(19) United States
(12) Patent Application Publication
(10) Pub. No.: US 2025/0294245 A1
(43) Pub. Date: Sep. 18, 2025

(54) Systems and Methods for an Indoor Camera That Triggers Based on Sound Detection

(71) Applicant: Vivint LLC, Provo, UT (US)

(72) Inventors: Justin Tran, Provo, UT (US); Connor Mickelson, Provo, UT (US); Nathan Maus, Provo, UT (US); Christopher Hall, Provo, UT (US); Erik Swenson, Provo, UT (US)

(73) Assignee: Vivint LLC, Provo, UT (US)

(21) Appl. No.: 19/081,845

(22) Filed: Mar. 17, 2025

Related U.S. Application Data
(60) Provisional application No. 63/566,124, filed on Mar. 15, 2024.

(51) Int. Cl. H04N 23/66; G08B 3/10; G08B 5/36; G08B 25/00

(52) U.S. Cl. CPC H04N 23/66; G08B 3/10; G08B 5/36; G08B 25/006

(57) ABSTRACT

Presented herein are system and methods for an indoor camera that can detect an audio event. The system can include an indoor camera, a control panel, and one or more processors coupled with non-transitory memory. The indoor camera can monitor an indoor environment. The indoor camera can capture audio data and visual data. The visual data can include images and/or videos. The indoor camera can detect, by analyzing audio data captured by the indoor camera, an audio event. The indoor camera can classify the audio event into a type of audio event. The indoor camera can transmit a message to the control panel, wherein the message indicates a type of the audio event. The control panel can receive messages and/or notifications from the indoor camera. The control panel can activate an alarm upon receiving the message having a particular type of audio event.

### CROSS REFERENCE

This application claims priority to United States Provisional Patent Application, 63/566,124, filed Mar. 15, 2024, and entitled SYSTEMS AND METHODS FOR AN INDOOR CAMERA THAT TRIGGERS BASED ON SOUND DETECTION, which is incorporated by reference herein in its entirety.

### TECHNICAL FIELD

This application generally relates to capturing audio data with a camera to activate a notification.

### BACKGROUND

Security and automation systems may be deployed in a smart environment (e.g., a residential, a commercial, or an industrial setting) to provide various types of communication and functional features such as monitoring, communication, notification, and/or others. These systems may be capable of supporting communication with a person through a communication connection or a system management action.

Security and automation systems may include one or more sensors for monitoring a home or a commercial business. Conventional security and automation systems may utilize a motion sensor or glass break sensor to trigger an alarm. However, many homes and businesses may not be configured with these types of sensors, so it may be desirable to trigger an alarm using other types of sensors without requiring manual intervention.

### SUMMARY

The systems and methods of this technical solution provide techniques for real-time monitoring and detection that trigger a panel based in an indoor environment. Conventionally, indoor cameras are not configured to trigger an alarm of a security system. As described herein, an indoor camera can detect audio and/or video, which can be used to accurately predict and respond to a variety of situational contexts, improving surveillance precision and effectiveness. By integrating advanced audio and/or video detection with responsive video recording, the system can rapidly adapt to changing environmental conditions and potential security threats.

An indoor camera may be configured to capture audio and/or video in a premises. The camera can analyze the signal captured and determine whether to classify the audio and/or video as an event, such as glass breaking, carbon monoxide alarm signals, smoke alarm signals, etc. The audio and/or video signal can be recorded for a time period before and/or after the detection of the event. The audio and/or video signal can be recorded in a memory for later retrieval. Upon detection of the event, an instruction may be transmitted to a control panel to activate an alarm, notify a first responder, notify a user, and/or trigger another action.

In one embodiment, a system can include an indoor camera, a control panel, and one or more processors coupled with non-transitory memory. The indoor camera can monitor an indoor environment. The indoor camera can capture audio data and visual data. The visual data can include images and/or videos. The indoor camera can detect, by analyzing audio data captured by the indoor camera, an audio event. The indoor camera can classify the audio event into a type of audio event. The indoor camera can transmit a message to the control panel, wherein the message indicates a type of the audio event. The control panel can receive messages and/or notifications from the indoor camera. The control panel can activate an alarm upon receiving the message having a particular type of audio event.

The indoor camera may be further configured to record a video that captures the detected audio event and transmit the video to the control panel.

The indoor camera may be further configured to classify the audio event using visual data of the detected audio event.

The audio event may comprise at least one of a breaking object sound, water flow sound, carbon monoxide alarm audio signal, or smoke alarm audio signal.

Activating the alarm may comprise alerting a first responder, depending on the classified type of the detected audio event. Activating the alarm may comprise starting a siren or turning on lights, depending on the classified type of the detected audio event. Activating the alarm may comprise generating and transmitting a notification to a device of a user, wherein the notification comprises an indication of the type of the audio event.

In another embodiment, a system may comprise a server remote from an indoor environment; and an indoor camera configured to monitor the indoor environment, wherein the indoor camera is configured to capture audio data and visual data, the indoor camera comprising one or more processors coupled with non-transitory memory and configured to: detect, by analyzing audio data captured by the indoor camera, an audio event; classify the audio event into a type of audio event; and transmit a message to the server, wherein the message indicates a type of the audio event, wherein the server is configured to activate an alarm upon receiving the message having a particular type of audio event.

The indoor camera may be further configured to record a video that captures the detected audio event and transmit the video to the server.

The indoor camera may be further configured to classify the audio event using visual data of the detected audio event.

The audio event may comprise at least one of a breaking object sound, water flow sound, carbon monoxide alarm audio signal, or smoke alarm audio signal.

Activating the alarm may comprise alerting a first responder, depending on the classified type of the detected audio event. Activating the alarm may comprise starting a siren or turning on lights, depending on the classified type of the detected audio event. Activating the alarm may comprise generating and transmitting a notification to a device of a user, wherein the notification comprises an indication of the type of the audio event.

### BRIEF DESCRIPTION OF THE DRAWINGS

The accompanying drawings constitute a part of this specification, illustrate an embodiment, and, together with the specification, explain the subject matter of the disclosure.

FIG. 1 is a block diagram of a system, according to an embodiment.

FIG. 2 is a block diagram of a system for an indoor camera that can detect an audio event, according to an embodiment.

FIG. 3 is a flow diagram of a method for an indoor camera that can detect an audio event, according to an embodiment.

### DETAILED DESCRIPTION

Disclosed herein are systems and methods for an indoor camera that triggers a panel based on sounds detection. Reference will now be made to the embodiments illustrated in the drawings, and specific language will be used here to describe the same. It will nevertheless be understood that no limitation of the scope of the disclosure is thereby intended. Alterations and further modifications of the features illustrated here, and additional applications of the principles as illustrated here, which would occur to a person skilled in the relevant art and having possession of this disclosure, are to be considered within the scope of the disclosure.

As described herein, an indoor camera may detect audio and/or video from inside a premises (e.g., residential or commercial property), and that detected signal may be analyzed to determine whether an event has occurred that should trigger a notification, such activating an alarm. Unlike a glass break sensor or a motion sensor, a camera may record the video of the event, which may be used to present to a user in a notification and/or may be used for further analysis of the event (e.g., determining if it is a false positive). Indoor cameras do not conventionally connect to a control panel or remote server that can trigger an alarm based on the event detected at the camera. Instead, conventional systems may require that a user confirm the occurrence of the event and cause a notification or instruction to first responders or others. For example, in an instance of a glass break sensor, a message sent to a control panel about a glass break event may require a user to communicate with a monitoring station using a control panel to determine if other should be contacted (e.g., first responders) and may even require entry of a passcode in the control panel. As described herein, the detection of an event, like a glass break, can trigger the control panel to contact certain parties and initiate an alarm sequence without user interaction at the control panel. Further, the embodiments may allow the use of video from a camera to confirm the occurrence of the event and record the event that was detected using the audio received at the camera.

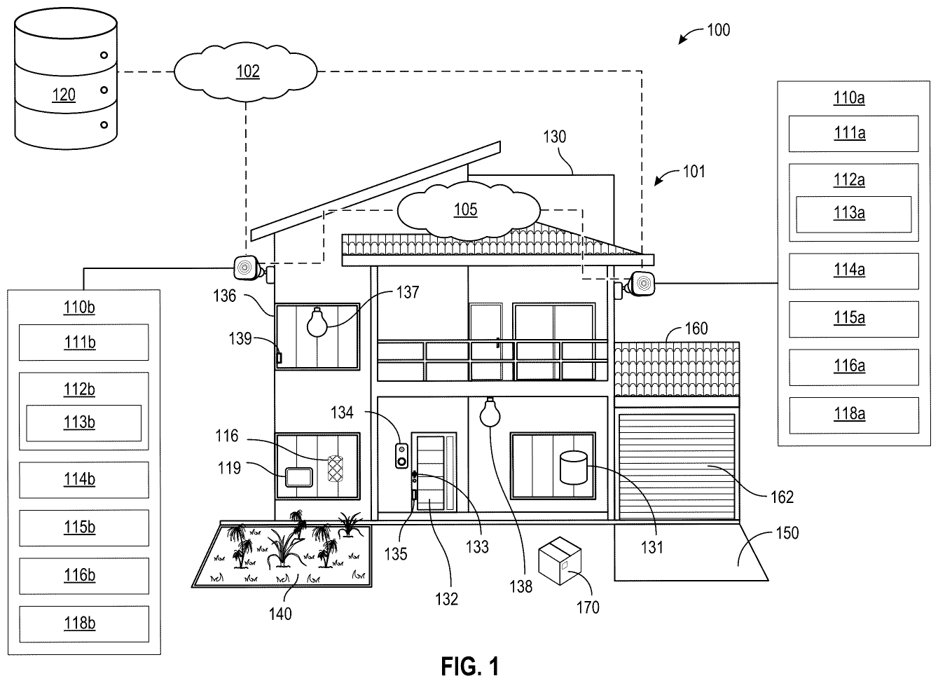

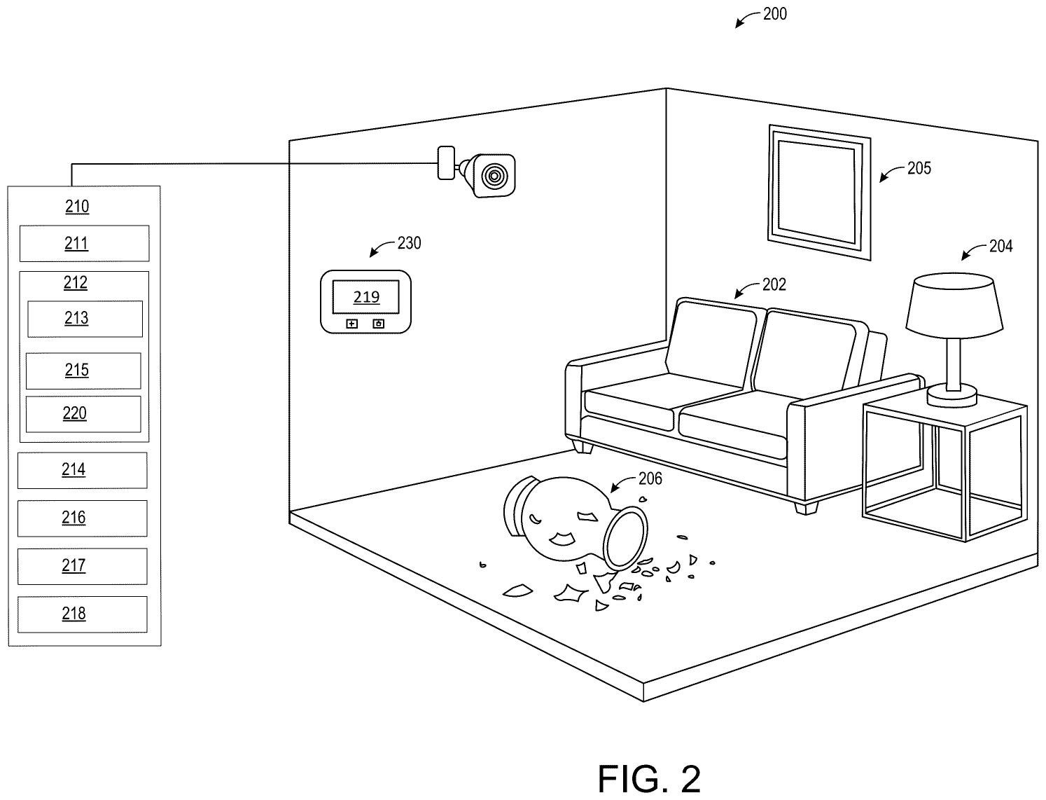

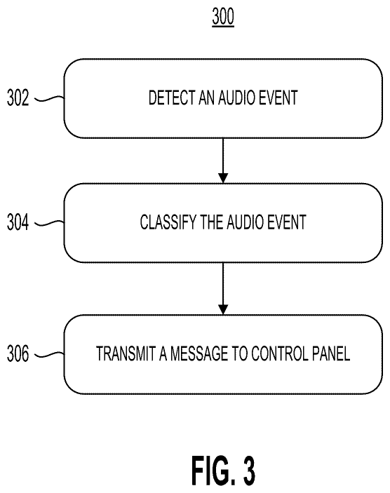

Though various configurations may be utilized to employ these embodiments, the description below shows an example environment of a building in FIG. 1, an example of a camera communicating with a control panel in FIG. 2, and an example process of detecting an event and triggering an alarm in FIG. 3.

FIG. 1 illustrates an example environment 100, such as a residential property, in which the present systems and methods may be implemented. The environment 100 may include a site that can include one or more structures, any of which can be a structure or building 130, such as a home, office, warehouse, garage, and/or the like. The building 130 may include various entryways, such as one or more doors 132, one or more windows 136, and/or a garage 160 having a garage door 162. The environment 100 may include multiple sites. In some implementations, the environment 100 includes multiple sites, each corresponding to a different property and/or building. In an example, the environment 100 may be a cul-de-sac that includes multiple buildings 130.

A first camera 110a and a second camera 110b, referred to herein collectively as cameras 110, may be disposed at the environment 100, such as outside and/or inside the building 130. The cameras 110 may be attached to the building 130, such as at a front door of the building 130 or inside of a living room. The cameras 110 may communicate with each other over a local network 105. The cameras 110 may communicate with a server 120 over a network 102. The local network 105 and/or the network 102, in some implementations, may each include a digital communication network that transmits digital communications. The local network 105 and/or the network 102 may each include a wireless network, such as a wireless cellular network, a local wireless network, such as a Wi-Fi network, a Bluetooth® network, a near-field communication (“NFC”) network, an ad hoc network, and/or the like. The local network 105 and/or the network 102 may each include a wide area network (“WAN”), a storage area network (“SAN”), a local area network (“LAN”) (e.g., a home network), an optical fiber network, the internet, or other digital communication network. The local network 105 and/or the network 102 may each include two or more networks. The network 102 may include one or more servers, routers, switches, and/or other networking equipment. The local network 105 and/or the network 102 may also include one or more computer readable storage media, such as a hard disk drive, an optical drive, non-volatile memory, RAM, or the like.

The local network 105 and/or the network 102 may be a mobile telephone network. The local network 105 and/or the network 102 may employ a Wi-Fi network based on any one of the Institute of Electrical and Electronics Engineers (“IEEE”) 802.11 standards. The local network 105 and/or the network 102 may employ Bluetooth® connectivity and may include one or more Bluetooth connections. The local network 105 and/or the network 102 may employ Radio Frequency Identification (“RFID”) communications, including RFID standards established by the International Organization for Standardization (“ISO”), the International Electrotechnical Commission (“IEC”), the American Society for Testing and Materials® (ASTM®), the DASH7™ Alliance, and/or EPCGlobal™.

In some implementations, the local network 105 and/or the network 102 may employ ZigBee® connectivity based on the IEEE 802 standard and may include one or more ZigBee connections. The local network 105 and/or the network 102 may include a ZigBee® bridge. In some implementations, the local network 105 and/or the network 102 employs Z-Wave® connectivity as designed by Sigma Designs® and may include one or more Z-Wave connections. The local network 105 and/or the network 102 may employ an ANT® and/or ANT+® connectivity as defined by Dynastream® Innovations Inc. of Cochrane, Canada and may include one or more ANT connections and/or ANT+ connections.

The first camera 110a may include an image sensor 115a, a processor 111a, a memory 112a, a depth sensor 114a (e.g., radar sensor 114a), a speaker 116a, and a microphone 118a. The memory 112a may include computer-readable, non-transitory instructions which, when executed by the processor 111a, cause the processor 111a to perform methods and operations discussed herein. The processor 111a may include one or more processors. The second camera 110b may include an image sensor 115b, a processor 111b, a memory 112b, a radar sensor 114b, a speaker 116b, and a microphone 118b. The memory 112b may include computer-readable, non-transitory instructions which, when executed by the processor 111b, cause the processor to perform methods and operations discussed herein. The processor 111a may include one or more processors.

The memory 112a may include an AI model 113a. The AI model 113a may be applied to or otherwise process data from the camera 110a, the radar sensor 114a, and/or the microphone 118a to detect and/or identify one or more objects (e.g., people, animals, vehicles, shipping packages or other deliveries, or the like), one or more events (e.g., arrivals, departures, weather conditions, crimes, property damage, or the like), and/or other conditions. For example, the cameras 110 may determine a likelihood that an object 170, such as a package, vehicle, person, or animal, is within an area (e.g., a geographic area, a property, a room, a field of view of the first camera 110a, a field of view of the second camera 110b, a field of view of another sensor, or the like) based on data from the first camera 110a, the second camera 110b, and/or other sensors.

The memory 112b of the second camera 110b may include an AI model 113b. The AI model 113b may be similar to the AI model 113a. In some implementations, the AI model 113a and the AI model 113b have the same parameters. In some implementations, the AI model 113a and the AI model 113b are trained together using data from the cameras 110. In some implementations, the AI model 113a and the AI model 113b are initially the same but are independently trained by the first camera 110a and the second camera 110b, respectively. For example, the first camera 110a may be focused on a porch and the second camera 110b may be focused on a driveway, causing data collected by the first camera 110a and the second camera 110b to be different, leading to different training inputs for the first AI model 113a and the second AI model 113b. In some implementations, the AI models 113 are trained using data from the server 120. In an example, the AI models 113 are trained using data collected from a plurality of cameras associated with a plurality of buildings. The cameras 110 may share data with the server 120 for training the AI models 113 and/or a plurality of other AI models. The AI models 113 may be trained using both data from the server 120 and data from their respective cameras.

The cameras 110, in some implementations, may determine a likelihood that the object 170 (e.g., a package) is within an area (e.g., a portion of a site or of the environment 100) based at least in part on audio data from microphones 118, using sound analytics and/or the AI models 113. In some implementations, the cameras 110 may determine a likelihood that the object 170 is within an area based at least in part on image data using image processing, image detection, and/or the AI models 113. The cameras 110 may determine a likelihood that an object is within an area based at least in part on depth data from the radar sensors 114, a direct or indirect time of flight sensor, an infrared sensor, a structured light sensor, or other sensor. For example, the cameras 110 may determine a location for an object, a speed of an object, a proximity of an object to another object and/or location, an interaction of an object (e.g., touching and/or approaching another object or location, touching a car/automobile or other vehicle, touching or opening a mailbox, leaving a package, leaving a car door open, leaving a car running, touching a package, picking up a package, or the like), and/or another determination based at least in part on depth data from the radar sensors 114.

The sensors, such as cameras 110, radar sensors 114, microphones 118, door sensors, window sensors, or other sensors, may be configured to detect occupancy. For example, the microphones 118 may be configured to sense sounds, such as voices, broken glass, door knocking, or otherwise, and an audio processing system may be configured to process the audio so as to determine whether the captured audio signals are indicative of the presence of a person in the environment 100 or building 130.

A user interface 119 may be installed or otherwise located at the building 130. The user interface 119 may be part of or executed by a device, such as a mobile phone, a tablet, a laptop, wall panel, or other device. The user interface 119 may connect to the cameras 110 via the network 102 or the local network 105. The user interface 119 may allow a user to access sensor data of the cameras 110. In an example, the user interface 119 may allow the user to view a field of view of the image sensors 115 and hear audio data from the microphones 118. In an example, the user interface may allow the user to view a representation, such as a point cloud, of radar data from the radar sensors 114. The user interface 119 may allow a user to provide input to the cameras 110. In an example, the user interface 119 may allow a user to speak or otherwise provide sounds using the speakers 116.

In some implementations, the cameras 110 may receive additional data from one or more additional sensors, such as a door sensor 135 of the door 132, an electronic lock 133 of the door 132, a doorbell camera 134, and/or a window sensor 139 of the window 136. The door sensor 135, the electronic lock 133, the doorbell camera 134 and/or the window sensor 139 may be connected to the local network 105 and/or the network 102. The cameras 110 may receive the additional data from the door sensor 135, the electronic lock 133, the doorbell camera 134 and/or the window sensor 139 from the server 120.

In some implementations, the cameras 110 may determine separate and/or independent likelihoods that an object is within an area based on data from different sensors (e.g., processing data separately, using separate machine learning and/or other artificial intelligence, using separate metrics, or the like). The cameras 110 may combine data, likelihoods, determinations, or the like from multiple sensors such as image sensors 115, the radar sensors 114, and/or the microphones 118 into a single determination of whether an object is within an area (e.g., in order to perform an action relative to the object 170 within the area. For example, the cameras 110 and/or each of the cameras 110 may use a voting algorithm and determine that the object 170 is present within an area in response to a majority of sensors of the cameras and/or of each of the cameras determining that the object 170 is present within the area. In some implementations, the cameras 110 may determine that the object 170 is present within an area in response to all sensors determining that the object 170 is present within the area (e.g., a more conservative and/or less aggressive determination than a voting algorithm). In some implementations, the cameras 110 may determine that the object 170 is present within an area in response to at least one sensor determining that the object 170 is present within the area (e.g., a less conservative and/or more aggressive determination than a voting algorithm).

The cameras 110, in some implementations, may combine confidence metrics indicating likelihoods that the object 170 is within an area from multiple sensors of the cameras 110 and/or additional sensors (e.g., averaging confidence metrics, selecting a median confidence metric, or the like) in order to determine whether the combination indicates a presence of the object 170 within the area. In some embodiments, the cameras 110 are configured to correlate and/or analyze data from multiple sensors together. For example, the cameras 110 may detect a person or other object in a specific area and/or field of view of the image sensors 115 and may confirm a presence of the person or other object using data from additional sensors of the cameras 110 such as the radar sensors 114 and/or the microphones 118, confirming a sound made by the person or other object, a distance and/or speed of the person or other object, or the like. The cameras 110, in some implementations, may detect the object 170 with one sensor and identify and/or confirm an identity of the object 170 using a different sensor. In an example, the cameras detect the object 170 using the image sensor 115a of the first camera 110a and verifies the object 170 using the radar sensor 114b of the second camera 110b. In this manner, in some implementations, the cameras 110 may detect and/or identify the object 170 more accurately using multiple sensors than may be possible using data from a single sensor.

In some implementations, the cameras 110 may monitor one or more objects based on a combination of data and/or determinations from the multiple sensors (e.g., the cameras 110 or microphones).

The environment 100 may include one or more regions of interest, which each may be a given area within the environment. A region of interest may include the entire environment 100, an entire site within the environment, or an area within the environment. A region of interest may be within a single site or multiple sites. A region of interest may be inside of another region of interest. In an example, a property-scale region of interest which encompasses an entire property within the environment 100 may include multiple additional regions of interest within the property.

The environment 100 may include a first region of interest 140 and/or a second region of interest 150. The first region of interest 140 and the second region of interest 150 may be determined by the AI models 113, fields of view of the image sensors 115 of the cameras 110, fields of view of the radar sensors 114, and/or user input received via the user interface 119. In an example, the first region of interest 140 includes a garden or other landscaping of the building 130 and the second region of interest 150 includes a driveway of the building 130. In some implementations, the first region of interest 140 may be determined by user input received via the user interface 119 indicating that the garden should be a region of interest and the AI models 113 determining where in the fields of view of the sensors of the cameras 110 the garden is located. In some implementations, the first region of interest 140 may be determined by user input selecting, within the fields of view of the sensors of the cameras 110 on the user interface 119, where the garden is located. Similarly, the second region of interest 150 may be determined by user input indicating, on the user interface 119, that the driveway should be a region of interest and the AI models 113 determining where in the fields of view of the sensors of the cameras 110 the driveway is located. In some implementations, the second region of interest 150 may be determined by user input selecting, on the user interface 119, within the fields of view of the sensors of the cameras 110, where the driveway is located.

In a further embodiment, the cameras 110 may perform, initiate, or otherwise coordinate, a welcoming action and/or another predefined action in response to recognizing a known human (e.g., an identity matching a profile of an occupant or known user in a library, based on facial recognition, based on bio-identification, or the like) such as executing a configurable scene for a user, activating lighting, playing music, opening or closing a window covering, turning a fan on or off, locking or unlocking a door 132, lighting a fireplace, powering an electrical outlet, turning on or play a predefined channel or video or music on a television or other device, starting or stopping a kitchen appliance, starting or stopping a sprinkler system, opening or closing a garage door 103, adjusting a temperature or other function of a thermostat or furnace or air conditioning unit, or the like. In response to detecting a presence of a known human, one or more safe behaviors and/or conditions, or the like, in some embodiments, the cameras 110 may extend, increase, pause, toll, and/or otherwise adjust a waiting/monitoring period after detecting a human, before performing a deter action, or the like.

In some implementations, the cameras 110 may receive a notification from a user's smart phone that the user is within a predefined proximity or distance from the home, e.g., on their way home from work. Accordingly, the cameras 110 may activate a predefined or learned comfort setting for the home, including setting a thermostat at a certain temperature, turning on certain lights inside the home, turning on certain lights on the exterior of the home, turning on the television, turning a water heater on, and/or the like.

The security system 101 and/or the one or more security devices, in some implementations, may escalate and/or otherwise adjust an action over time and/or may perform a subsequent action in response to determining (e.g., based on data and/or determinations from one or more sensors, from the multiple sensors, or the like) that the object 170 (e.g., a human, an animal, vehicle, drone, etc.) remains in an area after performing a first action (e.g., after expiration of a timer, or the like).

In some implementations, the cameras 110 and/or the server 120 (or other device), may include image processing capabilities and/or radar data processing capabilities for analyzing images, videos, and/or radar data that are captured with the cameras 110. The image/radar processing capabilities may include object detection, facial recognition, gait detection, and/or the like. For example, the controller 106 may analyze or process images and/or radar data to determine that a package is being delivered at the front door/porch. In other examples, the cameras 110 may analyze or process images and/or radar data to detect a child walking within a proximity of a pool, to detect a person within a proximity of a vehicle, to detect a mail delivery person, to detect animals, and/or the like. In some implementations, the cameras 110 may utilize the AI models 113 for processing and analyzing image and/or radar data.

In some implementations, the security system 101 and/or the one or more security devices are connected to various IoT devices. As used herein, an IoT device may be a device that includes computing hardware to connect to a data network and to communicate with other devices to exchange information. In such an embodiment, the cameras 110 may be configured to connect to, control (e.g., send instructions or commands), and/or share information with different IoT devices. Examples of IoT devices may include home appliances (e.g., stoves, dishwashers, washing machines, dryers, refrigerators, microwaves, ovens, coffee makers), vacuums, garage door openers, thermostats, HVAC systems, irrigation/sprinkler controller, television, set-top boxes, grills/barbeques, humidifiers, air purifiers, sound systems, phone systems, smart cars, cameras, projectors, and/or the like. In some implementations, the cameras 110 may poll, request, receive, or the like information from the IoT devices (e.g., status information, health information, power information, and/or the like) and present the information on a display and/or via a mobile application.

The IoT devices may include a smart home device 131. The smart home device 131 may be connected to the IoT devices. The smart home device 131 may receive information from the IoT devices, configure the IoT devices, and/or control the IoT devices. In some implementations, the smart home device 131 provides the cameras 110 with a connection to the IoT devices. In some implementations, the cameras 110 provide the smart home device 131 with a connection to the IoT devices. The smart home device 131 may be an AMAZON ALEXA device, an AMAZON ECHO, A GOOGLE NEST device, a GOOGLE HOME device, or other smart home hub or device. In some implementations, the smart home device 131 may receive commands, such as voice commands, and relay the commands to the cameras 110. In some implementations, the cameras 110 may cause the smart home device 131 to emit sound and/or light, speak words, or otherwise notify a user of one or more conditions via the user interface 119.

In some implementations, the IoT devices include various lighting components including the interior light 137, the exterior light 138, the smart home device 131, other smart light fixtures or bulbs, smart switches, and/or smart outlets. For example, the cameras 110 may be communicatively connected to the interior light 137 and/or the exterior light 138 to turn them on/off, change their settings (e.g., set timers, adjust brightness/dimmer settings, and/or adjust color settings).

In some implementations, the IoT devices include one or more speakers within the building. The speakers may be stand-alone devices such as speakers that are part of a sound system, e.g., a home theatre system, a doorbell chime, a Bluetooth speaker, and/or the like. In some implementations, the one or more speakers may be integrated with other devices such as televisions, lighting components, camera devices (e.g., security cameras that are configured to generate an audible noise or alert), and/or the like. In some implementations, the speakers may be integrated in the smart home device 131.

Within the environment 100 of FIG. 1, a camera may be positioned to view an indoor room or space within the building 130 and communicate with a control panel. An example of this indoor environment is shown in FIG. 2.

FIG. 2 illustrates an example indoor camera 210 in an indoor environment 200, such as a living room, in which the present systems and methods may be implemented. The indoor environment 200 may represent a common area within a structure or building (such as building 130 in FIG. 1), which may be a home, office, and/or the like. The indoor environment 200 may include entryways, such as doors or windows 205. The indoor environment 200 may include furniture such as a couch 202, lamp 204, and vase 206. The indoor camera 210 may be similar to camera 110 of FIG. 1 and may perform the features, functionalities, and capabilities of the cameras 110. The indoor camera 210 may capture audio data and visual data. The visual data may include image and/or video (e.g., as a sequence of frames). The indoor camera 210 may include a processor 211, a memory 212, AI models 213, a depth sensor 214 (e.g., radar sensor 214), a speaker 216, image sensors 217, and a microphone 218 that can include and perform the features, functionalities, and capabilities of the processor 211a, memory 212a/b, depth sensor 214a/b (e.g., radar sensor 214a/b), speaker 216a/b, image sensors 217, and microphone 218a/b respectively. The indoor camera 210 may be equipped with a battery backup system to ensure operation during power outages.

The indoor camera 210, via the microphone 218 and AI model 213, may identify or detect sounds that may indicate an event (e.g., a potential danger). The AI model 213 can be exposed and pre-trained to typical ambient sounds that constitute the normal auditory landscape of various indoor settings, including white noise, sound of human conversations, noises produced by household pets, hum of refrigerators, whirr of ceiling fans, ticking of clocks, and general household chatter. The AI model 213 may establish a baseline of what constitutes background noise within a given environment. The AI model 213 can be periodically or continuously trained through feedback loops. The AI model training may involve analyzing the actual audio data captured by the indoor camera 210 for the particular indoor environment 200 in which it operates. Through the training, the AI model 213 may dynamically adjust its baseline for normal sounds and background noise, accommodating changes in the environment such as new appliances, renovations, or alterations in indoor routines. The AI model 213 may be continuously trained using data from a local storage of the camera 210, a remote server, and/or other storage device.

Although the example embodiment recites the use of the AI model 213 to analyze the audio and/or video data from the camera 210 and output a determination of an event, it is intended that some embodiments may perform the analysis of the audio and/or video data from the camera may not utilize an AI model. Additionally, the processing of the data to detect and classify an event may occur on the camera 210, the control panel 230, on a local server, a remote server (e.g., cloud processing), or a combination of one or more of these devices, even though the example embodiment may recite performance on the camera for a simplified explanation.

The indoor camera 210, via the microphone 218 and AI model 213, may distinguish the normal sounds and background noise from auditory anomalies that may signal noteworthy events, such as potential threats. The indoor camera 210, via the microphone 218, may identify or detect vibrations or thumping sounds. The system can distinguish between a falling object (e.g., a broken vase 206) and a glass breaking (e.g., from window 205) in determining how to classify an event. The indoor camera 210 may also identify or detect flooding or major leaks by water flow sounds. The indoor camera 210 may identify or detect, via low-frequency sounds, malfunctions in heavy appliances or HVAC systems. The indoor camera 210 may identify or detect carbon monoxide alarm audio signals, smoke alarm audio signals, or other natural gas, radon, and security alarm audio signals. The indoor camera 210 can determine that the audio signal can be classified as an event based on a particular pattern, type, frequency, or other attribute of the sound within a period of time. These detected noise or sounds can be referred to as audio events or detected audio events. The camera 210, via the AI model 213 or other processor 211, may generate a description of the detected audio event (e.g., “broken glass detected,” “broken object detected,” “water leak detected,” “carbon monoxide alarm detected,” “smoke alarm detected,” etc.). The AI model 213 can classify the audio event into a type of audio event. The AI model 213 can utilize the visual data of the detected audio event to classify the audio data. The camera 210 may segment the signal to extract or define a time period, which may be a predetermined period of time, corresponding to that particular event. The time period of the signal can also have a corresponding video. In some configurations, upon detection of an event, the camera 210 may maintain a recording from a period of time (e.g., predetermined period of time) before the event and/or continue recording for a period of time (e.g., predetermined period of time) after the event.

The event may be classified according to various classifications, whereby a classification may trigger rules for subsequent actions. For example, an event that identifies an intruder may record video of the intruder (e.g., by detection of footsteps or breaking of a window), sound an alarm, contact first responders, and contact a user. In another example, an event that identifies a broken object that is not an entryway (e.g., a broken vase) may notify the user, but not notify first responders or sound an alarm.

The camera 210 via a motorized mechanism may pan, rotate, or tilt in various directions. The camera 210 may reposition itself in response to detected audio events and move, swivel, adjust its orientation, or point towards the source of the detected audio event. For example, if the camera 210, via microphone 218 and AI model 213, detects the sound of glass breaking from a direction within the indoor environment 200, the camera 210 may move, swivel, adjust its orientation, or point towards in that direction to provide a video feed of an area that includes the source of the detected audio event, such as the window 205 or the vase 206. The camera 210 may include a zoom-in or zoom-out feature. The camera 210 may include a night vision mode. The AI model 213 can turn on or off the night vision mode of the camera 210.

The camera 210 may perform or include continuous or buffer-based video recording. The memory 212 may include a temporary storage mechanism (e.g., a buffer 215). The buffer 215 may include a transitory holding space in the memory 212 for video data over a designated time interval (e.g., 1 min, 10 min, 30 min, 60 min, 90 min, 120 min, etc.), referred to as the buffer period. The buffer period may be selected by a user. The buffer 215 may retain the latest or most recent video data corresponding to the buffer period. For example, if the buffer period is 30 minutes, the buffer 215 may continuously update to include the latest 30 minutes of video recording. In some embodiments, the memory may be hosted on a server remote from the premises, such as a cloud server that can communicate with the camera.

When the camera 210 detects an audio event, the memory 212, via the processor 211, may save the video recording along with a time stamp from the buffer 215 to a more permanent storage location within the memory 212 (e.g., an event archive 220). The event archive 220 may store the video data from the buffer period and extend the video data for an additional designated time interval (e.g., 1 min, 10 min, 30 min, 60 min, 90 min, 120 min, etc.), referred to as the extended recording period. The event archive 220 may allow for capturing a more complete sequence of the detected audio events. For example, if an audio event is detected (such as the sound of glass breaking, which may be from window 205 or vase 206), the event archive 220 may store the video data from the buffer period (e.g., the most recent 30 minutes) and continue recording until the end of the extended recording period. The video data in the event archive 220 may allow for preservation for future reference or retrieval such as security analysis, evidence gathering, or review purposes.

By utilizing the buffer 215 and event archive 220, the camera 210 may ensure that only relevant video data (e.g., those that include detected audio event) is stored or preserved, thereby optimizing the use of memory 212 resources. The buffer 215, by continuously updating to hold only the latest video data for a user-defined buffer period, may serve as a memory 212 space for managing real-time footage. This approach may prevent the memory 212 from storing hours of non-essential video, which may rapidly consume storage space without adding value to the camera objectives of detecting audio events. The event archive 220 may include the video data coverage beyond the buffer period to include an extended recording period. The extended recording period may allow for the capturing of the full context of the detected audio event, including the moments leading up to and following the detected audio event. The AI model 213 can be periodically or continuously trained with the audio data of the buffer 215. The user-selected buffer period may allow for flexibility, enabling the camera 210 to adapt to different surveillance needs without unnecessarily occupying memory with extraneous footage.

A control panel 230 may be wall-mounted unit or a freestanding device. The control panel 230 may include a screen, a touchscreen, physical buttons, a keypad for entering security codes, and LED lights. The user interface 219 of the control panel 230 may be used to perform some of the features, functionalities, and capabilities of the control panel 230. The control panel 230 may include microphones with voice recognition capabilities for hands-free operation. The control panel 230 may use speakers (which may be part of the control panel 230 or be communicatively coupled thereto) to sound an alarm or transmit audio communicate for hands-free operation. The control panel 230 may allow users to listen in or communicate with someone near the camera 210 or control panel 230 (e.g., two-way communication). The control panel 230 may be equipped with a battery backup system to ensure operation during power outages.

The camera 210 and the camera 210 components may transmit information and data to the control panel 230 via hardware and/or network protocols such as local networks (e.g., Wi-Fi or Ethernet), wireless capabilities, Real Time Streaming Protocol (RTSP), WebRTC, and the like. The camera 210 may transmit information and data to a cloud server, from where the control panel 230 can access the transmitted information and data. The control panel 230 may connect to the cameras 210 and user devices (smart phone, tablet, computer, smart home device 131, etc.) via the network 102 or the local network 105 with wireless or wired connectivity.

In the example embodiment, the camera 210 transmits information and data to the control panel 230. In an alternative embodiment, the camera 210 may transmit to a server remote from the premises, such as a cloud server instead of passing through a control panel. The cloud server may transmit a notification to a user, activate an alarm, notify a first responder, and perform other functionality described herein as being performed herein by the control panel.

When an audio event is detected, the camera 210 can trigger the control panel 230 to take an action. The control panel 230 can also initiate a siren (e.g., horn) or turn on lights (e.g., strobe) depending on the nature of the detected event. The activation of a siren or lights can serve as an immediate, on-site deterrent to potential intruders or as a warning signal to occupants of the premises. The choice between starting a siren and turning on lights can be automated based on the type of detected audio event, ensuring an appropriate and effective response. For example, a breaking object sound can trigger the siren, while a carbon monoxide alarm can result in lights being turned on to alert occupants visually in situations where an audible alarm may not be effective. A trigger can also cause unlocking of doors and/or windows on the premises upon alerting a first responder to allow ease of access by the first responder. In some instances, the state of an alarm system may affect how an automation is triggered in the occurrence of different events. In an alternative embodiment, when the camera transmits to a cloud server, the camera can trigger to the cloud server to take an action, such as the actions described herein.

The control panel 230 may connect to a Wi-Fi network to access the internet. The control panel 230 may be equipped with cellular connectivity, and may use mobile data networks including 3G, 4G, or 5G to send notifications. The cellular connectivity can allow the control panel 230 to remain capable of accessing the internet in the event of power outage or absence of Wi-Fi network. The control panel 230 may connect to the user devices via an application or software downloaded on the user device. The control panel 230 may send messages and/or notifications to the user devices. The notifications may inform the users of regular system status updates, any detected audio events or anomalies, or emergencies requiring immediate attention. The control panel 230 may send notifications to the user devices via the application, downloaded software, or email. For application-based notifications, the control panel may utilize push notification services provided by various platforms including APPLE PUSH NOTIFICATION SERVICE or GOOGLE FIREBASE CLOUD MESSAGING. For local, short-range communication, the control panel 230 may connect to user devices via Bluetooth. The control panel 230 can establish communication with the user devices via standard messaging protocols, such as text messages or SMS (Short Message Service).

The control panel 230 may alert first responders (e.g., contact emergency services) in the event of a detected audio event that signifies an emergency (e.g., depending on the classified type of the detected audio event). When the control panel 230 detects the event that signifies an emergency, the control panel 230 can automatically contact emergency services, providing them with details about the nature of the event and its location).

The control panel 230 may generate a notification to a user. The control panel 230 may generate and display on its screen a description of the detected audio event (e.g., “broken glass detected,” “broken object detected,” “water leak detected,” “carbon monoxide alarm detected,” “smoke alarm detected,” etc.). The control panel 230 speakers may generate and emit various types of audio messages or alarms based on the nature of the detected audio event. For example, the control panel 230 can generate and activate an audio message that states that glass has broken when detecting breaking glass noise and may activate a loud alarm when a water leak is detected. The control panel 230 may display images or videos from the video data from the event archive 220. The control panel 230 may generate and transmit a message to another device, such as a text message to a mobile device or a push notification to display from an application on a mobile device, whereby the message may include an indicator of the event, including a link to the stored audio and/or video of the event.

The notification from the control panel 230 may include a message. The notification from the control panel 230 may include the description of the detected audio event (e.g., “broken glass detected,” “broken object detected,” “water leak detected,” “carbon monoxide alarm detected,” “smoke alarm detected,” etc.). The notification from the control panel 230 may include a time stamp that indicates the time that the audio event was detected. The notification from the control panel 230 may include images or videos from the video data from the event archive 220. The notification from the control panel 230 may include different audio alerts or verbal messages corresponding to the type of event detected. The notification from the control panel 230 may include security tips or recommendations for preventing similar incidents in the future.

Users may dismiss notifications directly from the control panel 230 and the user devices user interfaces. The control panel 230 and the user devices user interfaces may include an option to contact emergency services and connect the users to connects the user to local emergency responders. In one example, the system may monitor a premises using a user device such as the camera 210 or smart speaker, which may allow the user to also communicate (e.g., talk and/or listen) to the emergency responder or other security service through the camera 210 or smart speaker. In one configuration, the communication may include requesting a user to enter a password or perform speaker recognition to identify the person speaking as a member of the household (or other person who belongs at the premises) and not someone that has broken in (an intruder). The communication may also instruct the user to verify their identity using a user device, such as a mobile phone, which may consider that the user is driving or otherwise in route (e.g., to the premises upon the occurrence of the event). In that example, the user may receive audio instructions that account for the user's inability to interact directly with a touchscreen or other interface, such as when the user is driving. The communication may also utilize an interface, such as a chatbot, which may utilize a large language model (LLM) to communicate with the user to monitor, verify identity, obtain a passcode, assess the situation, and the like.

In an alternative embodiment, when a vehicle has been hit in a parking lot or nearby alarms are sounding, the vehicle can monitor these events and notify the user, a first responder, emit an alarm, or take another action. In this scenario, the premises may be the vehicle, and the vehicle may have one or more cameras. The functionality described herein may be applied to that system to allow for security and monitoring of the vehicle.

The control panel 230 and the user devices user interfaces may allow users to continue monitoring the situation beyond the extended recording period or the video recording in the event archive 220. The control panel 230 and the user devices user interfaces may allow users to remotely control various aspects of the camera 210 (e.g., pan, rotate, or tilt camera 210 in various directions; zoom in or zoom out of an area; switch on or adjust the night vision mode), adjust the buffer period, adjust the extended recording period, or remotely controlling other connected smart home devices 131. The control panel 230 and the user devices user interfaces may allow users to activate a privacy mode, which may temporarily disable recording and live streaming. The control panel 230 and the user devices user interfaces may allow users to remotely reboot the camera 210 (e.g., in case of software glitches or for troubleshooting).

FIG. 3 depicts a flow diagram of a method 300 for an indoor camera that can detect an audio event. In some examples, the method 300 may implement aspects of the environment 100, 200. For example, the method 300 may include example operations associated with one or more of a control panel 230, audio event, and indoor camera 210, which may be examples of the corresponding devices described with reference to FIG. 1 or 2. In brief overview of the method 300, a camera (e.g., the indoor camera 210, etc.) can monitor an indoor environment and capture audio data and visual data. The indoor camera can include one or more processors coupled with non-transitory memory that can detect, by analyzing audio data captured by the indoor camera, an audio event (step 302), classify the audio event into a type of audio event (step 304), and transmit a message to the control panel (step 306).

In further detail of method 300, at step 302, the indoor camera can capture audio and/or video data in an indoor environment. The indoor camera can continue to monitor the indoor environment and continue to process received data. By processing the data received at the camera, the camera can detect, by analyzing the audio data captured, an event. The indoor camera can record a video that captures the detected audio event. The audio event can include at least one of an intruder (e.g., footsteps), breaking object sound (e.g., broken window glass), water flow sound, carbon monoxide alarm audio signal, or smoke alarm audio signal. The length of the recording may be associated with the type of event.

At step 304, the indoor camera can classify the audio event into a type of audio event. The indoor camera can classify the audio event using visual data of the detected audio event. The visual data can include images and videos. By analyzing the visual data, the indoor camera can enhance its accuracy in determining the nature of the event (classify the event) and in differentiating between audio events that may have similar audio profiles but differ significantly in their visual aspects, thereby reducing false alarms and improving the reliability of the classification.

At step 306, the indoor camera can transmit a message to the control panel. The indoor camera can transmit the recorded video to the control panel. The control panel can activate an alarm upon receiving the message having a particular type of event. Depending on the classified type of the detected event, the control panel can alert first responders, start a siren, or turn on lights. Activating the alarm can include generating and transmitting a notification to a device of a user, wherein the notification comprises an indication of the type of the event. The control panel can present a video corresponding to the event as recorded by the camera, or the notification may include a link to the recorded video. In an alternative embodiment, with or without communicating with a control panel, the camera itself may activate an alarm from its speakers or transmit an instruction to a chime extending device or other external speaker.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then” and “next,” among others, are not intended to limit the order of the steps; these words are simply used to guide the reader through the description of the methods. Although process flow diagrams may describe the operations as a sequential process, many of the operations can be performed in parallel or concurrently. In addition, the order of the operations may be rearranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, among others, may be passed, forwarded, or transmitted via any suitable means including memory sharing, message passing, token passing, network transmission, etc.

The actual software code or specialized control hardware used to implement these systems and methods is not limiting. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A system, comprising:
a control panel; and
an indoor camera configured to monitor an indoor environment, wherein the indoor camera is configured to capture audio data and visual data, the indoor camera comprising one or more processors coupled with non-transitory memory and configured to:
detect, by analyzing audio data captured by the indoor camera, an audio event;
classify the audio event into a type of audio event; and
transmit a message to the control panel, wherein the message indicates a type of the audio event,
wherein the control panel is configured to activate an alarm upon receiving the message having a particular type of audio event.

2. The system of claim 1, wherein the indoor camera is further configured to record a video that captures the detected audio event and transmit the video to the control panel.

3. The system of claim 1, wherein the indoor camera is further configured to classify the audio event using visual data of the detected audio event.

4. The system of claim 1, wherein the audio event comprises at least one of a breaking object sound, water flow sound, carbon monoxide alarm audio signal, or smoke alarm audio signal.

5. The system of claim 1, wherein activating the alarm comprises alerting a first responder, depending on the classified type of the detected audio event.

6. The system of claim 1, wherein activating the alarm comprises starting a siren or turning on lights, depending on the classified type of the detected audio event.

7. The system of claim 1, wherein activating the alarm comprises generating and transmitting a notification to a device of a user, wherein the notification comprises an indication of the type of the audio event.

8. A system, comprising:
a server remote from an indoor environment; and
an indoor camera configured to monitor the indoor environment, wherein the indoor camera is configured to capture audio data and visual data, the indoor camera comprising one or more processors coupled with non-transitory memory and configured to:
detect, by analyzing audio data captured by the indoor camera, an audio event;
classify the audio event into a type of audio event; and
transmit a message to the server, wherein the message indicates a type of the audio event,
wherein the server is configured to activate an alarm upon receiving the message having a particular type of audio event.

9. The system of claim 8, wherein the indoor camera is further configured to record a video that captures the detected audio event and transmit the video to the server.

10. The system of claim 8, wherein the indoor camera is further configured to classify the audio event using visual data of the detected audio event.

11. The system of claim 8, wherein the audio event comprises at least one of a breaking object sound, water flow sound, carbon monoxide alarm audio signal, or smoke alarm audio signal.

12. The system of claim 8, wherein activating the alarm comprises alerting a first responder, depending on the classified type of the detected audio event.

13. The system of claim 8, wherein activating the alarm comprises starting a siren or turning on lights, depending on the classified type of the detected audio event.

14. The system of claim 8, wherein activating the alarm comprises generating and transmitting a notification to a device of a user, wherein the notification comprises an indication of the type of the audio event.

15. A method, comprising:
detecting, by a processor of an indoor camera, an audio event by analyzing audio data captured by the indoor camera from an indoor environment corresponding to the indoor camera;
classify, by the processor, the audio event into a type of audio event; and
transmit, by the processor, a message to control panel in communication with the indoor camera, wherein the message indicates a type of the audio event, wherein the control panel is configured to activate an alarm upon receiving the message having a particular type of audio event.

16. The method of claim 15, further comprising recording, the by the indoor camera, a video that captures the detected audio event and transmit the video to the control panel.

17. The method of claim 15, further comprising classifying, by the indoor camera, the audio event using visual data corresponding to the detected audio event.

18. The method of claim 15, wherein the audio event comprises at least one of a breaking object sound, water flow sound, carbon monoxide alarm audio signal, or smoke alarm audio signal.

19. The method of claim 15, wherein activating the alarm comprises alerting a first responder based on the classified type of the detected audio event.

20. The method of claim 15, wherein activating the alarm comprises starting a siren or turning on lights, depending on the classified type of the detected audio event.
